(19) United States
(12) Patent Application Publication
(10) Pub. No.: US 2014/0325133 A1
(43) Pub. Date: Oct. 30, 2014

(54) AMOUNT OF MEMORY FOR EXECUTION OF AN APPLICATION

(71) Applicants: Walter A. Gaspard, Magnolia, TX (US); Fred Charles Thomas, III, Fort Collins, CO (US); Chi W. So, Spring, TX (US); Christoph J. Graham, Houston, TX (US)

(72) Inventors: Walter A. Gaspard, Magnolia, TX (US); Fred Charles Thomas, III, Fort Collins, CO (US); Chi W. So, Spring, TX (US); Christoph J. Graham, Houston, TX (US)

(21) Appl. No.: 14/354,561

(22) PCT Filed: Nov. 21, 2011
(86) PCT No.: PCT/US11/61689

§ 371 Date: Jul. 16, 2014

(51) Int. Cl. G06F 12/02

(52) U.S. Cl. CPC G06F 12/0238
USPC 711/103; 711/154; 711/118

(57) ABSTRACT

Examples disclose determining an amount of memory for execution of an application, associated with a user preference, based on an inspection of data associated with the application. Further the example discloses transmitting a request to a non-volatile memory to allocate a segment corresponding to the amount of memory for execution of the application. Additionally, the example also discloses receiving a response of the amount of memory available for the segment and reserving a portion of the segment for the execution of the application.

### BACKGROUND

Applications on computing devices have become numerous in the last several years, however, the computing devices have limited capabilities to efficiently execute these applications. Applications stored in disk drive are stored in a stack, so in order to access the application, it must be done in first in, first out order, thus taking much time to access the application producing a longer response time to render to the user. Frequently accessed applications may be preserved for quicker access through caching, however, this can become cost prohibitive as cache memory is more expensive. Additionally, memory is limited in size and as such caching an entire application takes up much space, overwriting existing cached applications and slowing the efficiency of the computing device. Further, applications may be preserved according to an operation system which may lead to applications being cached a user may not desire to cache.

In addition, limiting the data related to the application to cache requires technical knowledge from a user to understand how to cache the data and available memory capacity. For example, the use may want to cache an execution file of an application rather than the full application, but this requires the user to know the understanding of the components of the application and/or memory for the user to complete manually.

### BRIEF DESCRIPTION OF THE DRAWINGS

In the accompanying drawings, like numerals refer to like components or blocks. The following detailed description references the drawings, wherein:

FIG. 1 is a block diagram of an example computing device for reserving a portion of a segment for execution of an application;

FIG. 2 is a block diagram of an example data related to an application;

FIG. 3 is block diagram of an example computing device with a solid state drive and a disk drive to inspect a data related to an application by either the computing device or server;

FIG. 4 is a flowchart of an example method performed on a computing device for determining an amount of memory to reserve a portion of a segment of a non-volatile memory;

FIG. 5 is a flowchart of an example method performed on a co computing device to cache data related to an application; and

FIG. 6 is a block diagram of an example computing device to determine an amount of memory based on an inspection of a data related to an application.

### DETAILED DESCRIPTION

Memory limitations such as cost and space cause inefficient application execution and computing device performance. To address these issues, various examples disclosed herein provide determining an amount of memory, associated with a user preference, for execution of an application based on an inspection of data related to the application and reserving memory. The determined amount of memory for execution of the application is considered smaller in size then reserving space for the full application. This allows the non-volatile memory to reserve memory space for the data related to the application for a more efficient execution of the application.

Additionally, the various examples disclosed herein determining the amount of memory associated with a user preference, provides preservation of data related to the application in the non-volatile memory for immediate response to a user. In preserving the data, allows the user control over which applications and additional data to preserve for faster access to applications.

In particular, examples provide a computing device associated with the user preference to determine the amount of memory based on an inspection of the data related to the application. Further, the computing device transmits a request to a non-volatile memory to allocate a segment corresponding to the amount of memory. Additionally, the computing device receives a response of the amount of memory available for the segment and based on this response, reserves a portion of the segment for execution of the application. Data related to an application includes a logical block address and/or a file. Embodiments of the file include an application code, a library, a media, a configurable file, and/or executable file.

In one embodiment, the computing device may also cache the data related to the application in the portion of the segment of the non-volatile memory. In a further embodiment, the user preference includes at least one of run-time analysis, read write operation count, or a user interface. In this respect, the user preference allows the user to control which application execution to preserve for quicker access. For example, the user may desire quicker access to specific applications. The retrieval for application execution from the non-volatile memory takes a shorter time period than from a disk drive, producing a more responsive time to render the application to the user. In these example, the limited non-volatile memory space is optimized from a user's perspective to efficiently run and preserve these applications for quicker access.

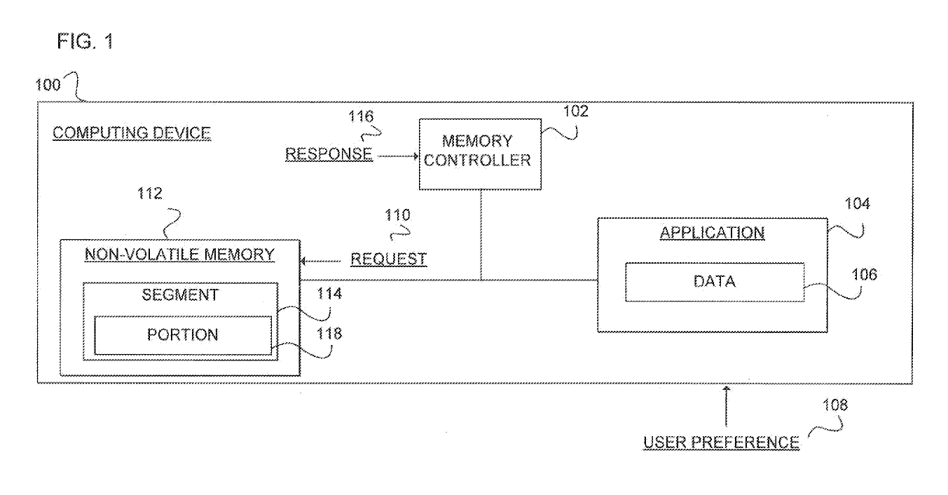

Referring now to the drawings, FIG. 1 is a block diagram of an example computing device 100 for determining an amount of memory and reserving a portion 118 of a segment 114 within the non-volatile memory 112 for execution of an application 104. The computing device 100 includes a memory controller 102, application 104, and a non-volatile memory 112. Embodiments of the computing device 100 include a client device, personal computer, desktop computer, laptop, a mobile device, a portable device, or other computing device suitable to include components 102, 104, and 112. Further, it is to be understood although the computing device 100 includes the depicted components 102, 104, and 112, it should not be limited to containing the components in FIG. 1. For example, the computing device 100 may contain a processor in addition to the memory controller 102 and/or additional memory. In a further embodiment, the computing device 100 includes a hard drive that maintains the application 104.

A memory controller 102 inspects data 106 related to the application 104 to determine an amount of memory for execution of the application 104. Further, the memory controller 102 determines the amount of memory from the inspection of data 106 associated with the user preference 108. Additionally, the memory controller 102 transmits a request 110 to the non-volatile memory 112 to allocate a segment 114 corresponding to the determined amount of memory. Further still, the memory controller 102 receives a response 116 from the non-volatile memory 112 on the amount of memory available for the segment 114. Based on this response 116, the memory controller 102 reserves a portion 118 of the segment 114 for the application execution. Embodiments of the memory controller 102 include a central processing unit (CPU), microprocessor, processor graphics processing unit (GPU), visual processing, unit (VPU), or other programmable device suitable to inspect data 106 related to the application 104, transmit request 110, and receive response 116.

The application 104 includes data 106 related to the application 104. Embodiments of the application 104 include software, program, instructions, procedures, or algorithm to enable the computing device 100 to perform a task. Further embodiments of the application 104 includes data 106 required for the application to execute and operate. For example, the application 104 includes the graphics, media, libraries, launch files, executable files, and the logical block addresses. Yet, a further embodiment of the application 104 includes the full application with all the components of data 106 to execute and operate the application 104.

Data 106 related to the application 104 is used for, inspection to determine the amount of memory in the non-volatile memory 112 for execution of the application 104. Using data 106 for inspection, a smaller amount of memory is reserved for application 104 execution rather than the full application 104, this also allows guidance over what to reserve and/or cache into the non-volatile memory 112. For example, the full application, may include all related data to execute and operate, while embodiments of data 106 related to the application 104 include the logical block address or a file for execution of the application 104. The logical block address may be used for specifying the location of data blocks on a memory for the application 104 to execute. The file may include the application code, the executable file, the launch file, the media, and/or the library as seen in later figures. Inspecting data 106 as the logical block address or the file enables a determination of the amount of memory space for execution of the application 104. Further, data 106 may also include additional components besides the execution of the application 104. For example, in a gaming application 104, data 106 may include files for execution and graphics. Since data 106 are components for execution and operation of the application 104, data 106 is considered related to the application 104. In an embodiment, data may 106 include logical block address specifying the location of data blocks for execution of the application 104. In a further embodiment, data 106 may include files related to the application 104 for execution of the application 104. Further still, in another embodiment, data 106 may also include files for execution of the application 104 and additional files to optimize the performance the application 104, such as the library or the media. For example, in a gaming application 104, media related to the game to render to the user may be beneficial for performance of the application 104. The beneficial performance of the application 104 includes by reserving and/or caching data 108 related to the application 104, the response time for the application to execute and become accessible for the user can be reduced and create a positive experience for the user.

The memory controller 102 determines the amount of memory for execution of the application 104. The determined amount of memory is the amount of space that is to be reserved and/or cached in the non-volatile memory 112. This determined amount of memory for execution of the application 104 is associated with the user preference 108. The user preference 108 is a way of optimizing the amount of space in the non-volatile memory 112 from a user's perspective to efficiently run and preserve execution of the application 104 for quicker access. Embodiments of the user preference 108 include a run-time analysis, a read write operation count, or a user interface. The read write operation count tracks the number of times the application 104 may be retrieved and written to a hard drive or disk drive. Utilizing a run-time analysis or read write operation count as the user preference 108, may include reaching a particular threshold and once reaching the threshold, the memory controller 102 determines the amount of Memory for execution of the application 104. Reaching a particular threshold may be an indication the particular application 104 should be preserved in the non-volatile memory 112 for quicker access. The user interface may include a graphical user interface for a user to interact with to control which application 104 execution is to be reserved in the non-volatile memory 112. In another embodiment, the user interface is an input that allows the user of the computing device control over which applications and files related to the application 104 may be reserved for caching into the non-volatile memory 112. Although the user preference 108 is illustrated as outside of the computing device 100, it should not be limited to this embodiment. For example, the user preference 108 may include a read write operation count to track how often data 106 related to an application 104 is accessed from a disk drive. In this example, the user preference 108 is received locally from the computing device 100 from a processor or memory controller 102. As a further example, a user of the computing device 100 may interact with a graphical user interface to determine the amount of memory for data 106 related to the application 104. In this example, the user of the computing device 100 may drag and drop a launch file from application 104 to determine the amount of memory for the launch file.

The memory controller 102 transmits the request 110 to the non-volatile memory 112. The request 110 is a transmission to the non-volatile memory 112 to allocate the segment 114 corresponding to the determined amount of memory for execution of the application 104. The amount of memory is determined after inspection of data 106 related to the application 104. Embodiments of the request 110 include a communication, transmission, electrical signal, instruction, digital signal, analog signal, or other type of communication to allocate the segment 114 corresponding to the determined amount of memory for execution of the application 104.

The non-volatile memory 112 receives the request 110 to allocate the segment 114 corresponding to the amount of memory determined for execution of the application 104. The non-volatile memory 112 is a memory that can retain stored information even when not powered. Embodiments of the non-volatile memory 112 include a non-volatile storage, read-only memory (ROM), flash memory, memristor, ferroelectric random access memory (RAM), hard disk, floppy disk, hard drive, magnetoresistive random access memory (MRAM), nanodrive, solid-state drive, or other suitable component to receive a request 110 to allocate the segment 114 for an amount of memory and transmit a response 116 on the memory available for the segment 114.

The segment 114 corresponds to the amount of memory determined from an inspection of data 106 related to the application 106. The segment 114 refers to the space within the non-volatile memory 112 available for data 106 related to the application 104. Thus, the segment 114 may be reserved and/or cached for data 106 related to the application 104. Unlike a data block that is preconfigured in memory, the segment 114 operates in a dynamic manner to configure the amount of space in the non-volatile memory 112 to execute application 104. For example, a gaming application may include data 106 that takes a larger segment 114 of non-volatile memory 112 as opposed to a word processing document application that may take a smaller segment 114 of the non-volatile memory 112. Accordingly, to execute the word processing document application the segment 114 is smaller in size than the segment 114 to execute the gaming application.

The portion 118 is reserved for execution of the application 104. Embodiments of the portion 118 include similar memory space to the segment 114, other embodiments depict the portion 118 using less memory space than the segment 114. In this regard, the amount of memory as determined from the inspection of the data 106 related to the application 104 for execution of the application 104, may be smatter in space memory than allocated for the segment 114. In another embodiment, the portion 118 may include one or several portions 118 within the segment 114.

The non-volatile memory 112 transmits the response 116 to the memory controller 102. The response 118 is a transmission to the memory controller 102 in the amount of memory available in the non-volatile memory 112 for the segment 114 to execute the application 104. Embodiments of the response 116 include a communication, transmission, electrical signal, instruction, or other type of communication regarding the memory available for the segment 114. In another embodiment of the response 116, the space available for the segment 114 may be larger in memory space than in the request 110. In this embodiment, files in addition to the execution of the application 104, such as a library, may also be reserved to the segment 114.

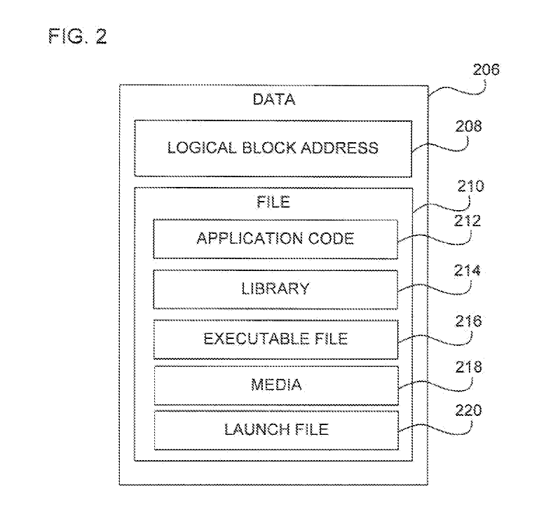

Turning now to FIG. 2, a block diagram of an example data 206 related to an application is depicted including a logical block address 208 and/or a file 210. Data 206 includes the functionality of data 106 as discussed in FIG. 1. Specifically, FIG. 2 illustrates file 210 may include at least one of an application code 212, a library 214, an executable. file 216, a media 218, and a launch file 220. Additionally, FIG. 2 depicts data 206 Irrespective of location, thus data 206 may be located on the non-volatile memory 112 or with application 104 as in FIG. 1. Inspecting the logical block address 208 and/or file 210, an amount of memory is determined for execution of the application. The determined amount of memory corresponds to an amount of space of a non-volatile memory for execution of the application. Inspecting the logical block address 208 and/or file 210 the amount of memory to execute the application may include the entire application or a specific file 210 related to the application, such as the launch file 220. For example, rather than determining the full amount of memory of the application, the launch file 220 may execute the application and as such the launch file 220 may be inspected or the logical block address 208 designating the blocks of memory of the launch file 220 to determine the amount of memory.

The logical block address 208 is a scheme used for specifying locations of file 210 within a data block. Inspecting the logical block address 208 determines the amount of memory to execute the application or specific data related of the application, such as the executable file 216. Embodiments of the logical block address 208 includes a cylinder-header-sector scheme, sector based addressing, physical block address, mapping address, disk sector, or other address 208 suitable to represent the amount of memory for execution of the application.

Data 206 related to the application may include at least one of the logical block address 208 and/or file 210. Inspecting file 210 or logical block address 208, determines the amount of memory for execution of the application. For example, file 210 related to the application may include launch file 220 and as such after inspection, launch file 220 takes a smaller amount of memory rather than the full application. In another embodiment of data 200 includes other components related to the application to optimize performance of the application, such as the media 218 and/or library 220.

File 210 may include at least one of the application code 212, the library 214, the executable file 216, the media 218, and/or the launch file 220. Additionally, file 210 may include any one or combination of 212, 214, 216, 218, and 220. File 210 includes the files related, to the application. For example, for the application to execute, it may include the launch file 220 as part of file 210.

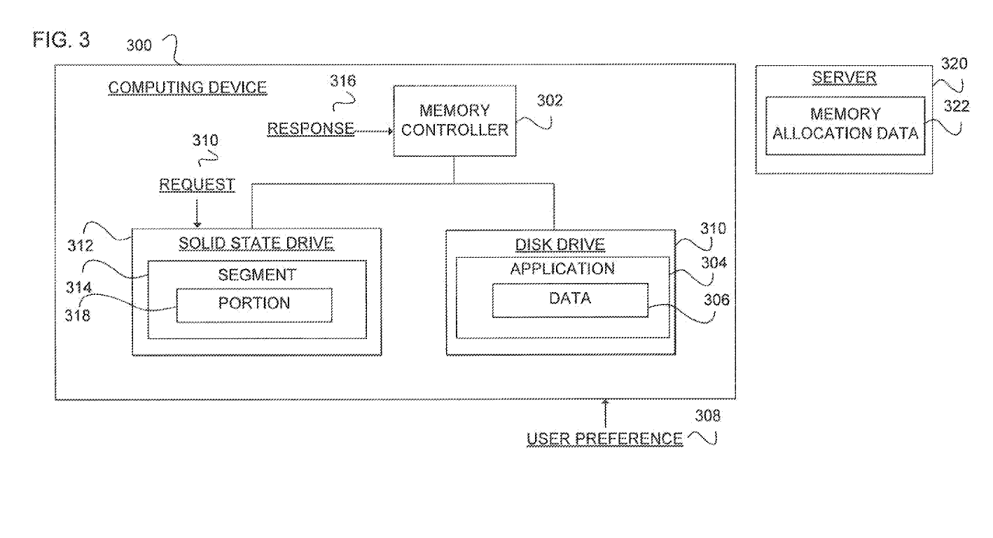

Moving to FIG. 3, is a block diagram of an example computing device 300 with a solid state drive 312 and a disk drive 310. FIG. 3 also depicts the computing device 300 to inspect data 306 related to an application 304 by either the computing device 300 or a server 320 with memory allocation data 322. The computing device 300 includes the functionality of the computing device 100 in FIG. 1 as set forth above.

Memory controller 302, associated with a user preference 308, determines an amount of memory based on an inspection of data 306 related to the application 304 for execution of the application 304. Embodiments of the determined amount of memory may be retrieved from the server 320, while in other embodiments, the memory controller determines the amount of memory. Further, the memory controller 302 transmits a request 310 to the solid state drive 312 to allocate a segment 314 based on the determined amount of memory. Additionally, the memory controller 302 receives a response 316 from the solid state drive 312 that indicates the amount of memory available for the segment 314. The memory controller 102 includes the functionality of the memory controller 102 as set forth above in FIG. 1.

Disk drive 310 includes data 306 related to the application 304. The disk drive 310 is a non-volatile random access data storage that maintains the application 304. In one embodiment, data 306 related to the application 304 is magnetically read from and written to the disk drive 310, thus the memory controller 302 tracks the count of the read and writes of data 306 to the disk drive 310, an embodiment of the user preference 308. For example, the more often the user of the computing device 300 desires to execute an application 304, the higher the count of the reads and writes of data 306 to the disk drive 310, thus it may reach a threshold count and indicates the user preference 308.

Application 304 maintained at the disk drive 310 includes data 306 related to the application 304. The application 304 includes the functionality of the application 104 as set forth above in FIG. 1. Data 306 related to the application 304 is inspected to determine the amount of memory for execution of the application 304. Data 306 includes the functionality of data 106 and 206 as set forth above in FIG. 1 and FIG. 2.

Determining the amount of memory in the solid state drive 312 for execution of the application 304 is based on the user preference 308. User preference 308 includes the functionality of the user preference 108 as set forth above in FIG. 1. Embodiments of the user preference 308 include a run-time analysis, read write operation count, and a user interface. Inspection of data 306 related to the application 304 determines the amount of memory for execution of the application 304. In one embodiment, the memory controller 302 determines the amount of memory while in a further embodiment, the memory controller 302 inspects data 306 to determine the amount of memory by communicating with the server 320. For example, the memory controller 302 may query the amount of memory to execute a word processing application 304. As such, the computing device 300 communicates with the server 320 to obtain the determined amount of memory to execute the word processing application 304.

The server 320 includes the memory allocation data 322. The server 320 provides services across a network and my include, for example, a web server, network server, a Local Area Network (LAN) server, a file server, or any other computing device suitable to maintain memory allocation data 322. The server 320 maintains the memory allocation data 322 that specifies the amount of memory for execution of the application 304. During the inspection of data 306 related to the application 304, the memory controller 302 communicates with the server 320 to obtain the memory allocation data 322.

The memory allocation data 322 may be stored and/or maintained on the server 320. The memory allocation data 322 specifies the amount of space for execution for a particular application 304. In keeping with the prior example, the word processing application 304, the computing device 300 communicates with the server 320 to determine the amount of memory for execution. An embodiment of the memory allocation data 322 includes a database in communication with the server 320 while in a further embodiment, the memory allocation data 322 is within a storage area on the server 320. In both of these embodiments, the server 320 has the knowledge of the particular application 304 and the memory allocation data 322.

The request 310 is transmitted by the memory controller 102 to the solid state drive 312 to allocate the segment 314 corresponding to the amount of memory determined for execution of the application 304. The request 310 includes the functionality of the request 116 as set forth above in FIG. 1.

The solid state drive 312 is a data storage that uses solid state memory to receive a request 310 and allocate the segment 314. The solid state drive 312, unlike the disk drive 310, utilizes an integrated circuit to retain data and contains no physically moving components. In an embodiment of the solid state drive 312 includes a cache memory for execution of the application 304. The solid state drive 312 includes the functionality of the non-volatile memory 112 as see in FIG. 1.

The segment 314 is an area of memory within the solid state drive 312 and includes a portion 318. The segment 314 includes the functionality of the segment 114 as set forth above in FIG. 1. The portion 318 of the segment 314 may be reserved by the memory controller 302 for execution of the application 304 depending on the response 316. Embodiments of reserving the portion 318 includes pinning data 306, caching data 306, flagging the portion 318, or restricting access of the portion 318 to data 306 or the related to the application 304. The portion 318 includes the functionality of the portion 118 as set forth above in FIG. 1.

The response 316 includes the amount of memory available for the segment 314 in the solid state drive 312. Based on the response 316, the memory controller 302 reserves the portion 318 of the segment 314 for execution of the application 304. For example, if there is no available memory for the segment 314, the memory controller 102 would be unable to reserve the portion 318 of the segment 314 for execution of the application 304. The response 316 includes the functionality of the response 116 as set forth above in FIG. 1.

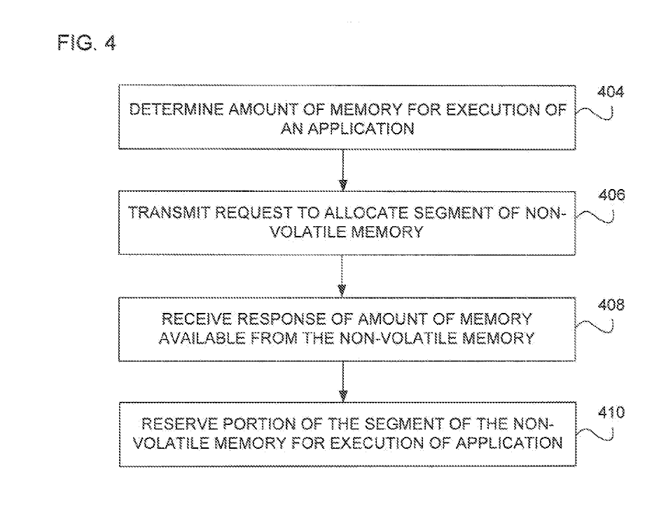

Turning now to FIG. 4, a flowchart of an example method performed on a computing device to determine an amount of memory for execution of an application. Although FIG. 4 is described as being performed on computing device 100 as in FIG. 1, it may also be executed on other suitable components as will be apparent to those skilled in the art. For example, FIG. 4 may be implemented in the form of executable instructions on a machine readable storage medium, such as memory 112.

Operation 404 is performed such that a controller operating in conjunction with the computing device may determine an amount of memory for execution of the application. Specifically, operation 404, includes determining the amount of memory, associated with a user preference, for execution of the application. Additionally, operation 404 includes determining the amount of memory based on an inspection of data related to the application. An embodiment of operation 404 includes the computing device with the non-volatile memory inspecting the data related to the application to determine the amount of memory, while a further embodiment of operation 404 includes determining the amount of memory from a server that contains memory allocation data. Embodiments of determining the amount of memory for execution of the application includes a partial execution of the application or the full execution of the application and as such may include all data to execute the application or a single file for execution of the application. Embodiments of the user preference includes at least one of a run-time analysis, a read write operation count, and a user interface.

At operation 406 the memory controller transmits a request to allocate a segment of the non-volatile memory, The segment corresponds to the amount of non-volatile memory for execution of the application as determined at operation 404. The segment refers to the space within the non-volatile memory available for files and/or data related to the application. Thus, the segment may be reserved and/or cached for the data and/or files related to the application.

At operation 408 the memory controller receives a response of the amount of memory available from the non-volatile memory. The response indicates the amount of memory space available in the non-volatile memory for the segment. An embodiment of operation 408 includes if there is not enough available space for the segment, the operation ceases at 408 and will not reserve the available space for execution of the application.

At operation 410, based on the response received at operation 408, a portion of the segment is reserved for execution of the application. Specifically, the portion of the segment within the non-volatile memory is reserved by the memory controller. In an embodiment of operation 410 if the response indicates there is not enough space available for the segment, the method ceases at operation 408. In this embodiment, the reservation of the portion of the segment of the non-volatile memory is based on the response received at operation 408 which indicates the memory available on the non-volatile memory. In a further embodiment of operation 410, the file of the data related to the application is cached for execution of the application, while another embodiment of operation 410 includes pinning the file to the segment of the non-volatile memory. Yet in further embodiments of operation 410 includes pinning data, caching data, flagging the portion, or restricting access of the portion of the non-volatile memory to data and/or files related to the application.

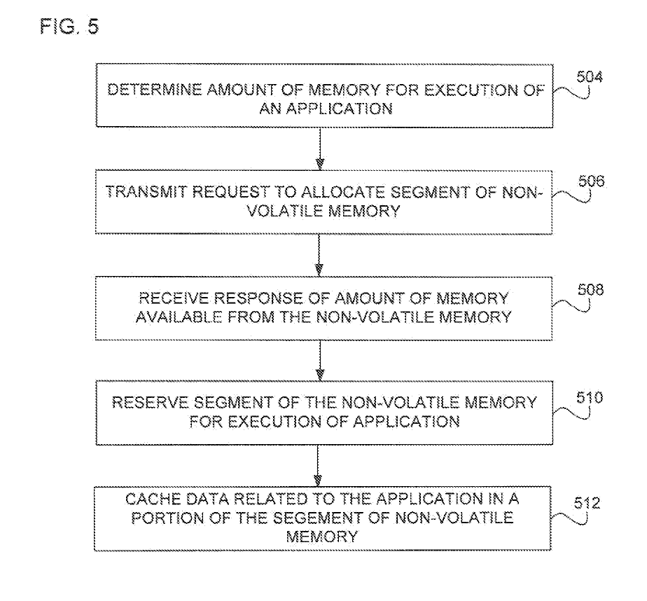

Referring now to FIG. 5, a flowchart of an example method performed on a computing device to cache data related to the application in a portion of a segment within a non-volatile memory. Although FIG. 5 is described as being performed on the computing device 100 as in FIG. 1, it may also be executed on other suitable components as will be apparent to those skilled in the art. For example, FIG. 5 may be implemented in the form of executable instructions on a machine readable storage medium, such as the non-volatile memory 112.

At operations 504-510, the computing device determines an amount of memory, associated with a user preference, for execution of an application based on an inspection of data related to the application. Further, at operations 504-510, the computing device transmits a request to allocate a segment of the non-volatile memory and receives a response of the amount of memory available for the segment in the non-volatile memory. Additionally, at operations 504-510, the computing device reserves the segment of the non-volatile memory for execution of the application. Embodiments of operations 504-510 include the functionality of operations 404-410 as seen in FIG. 4.

At operation 512, the computing device caches the data related to the application in a portion of the segment of the non-volatile memory. Embodiments of operation 512 include caching the file related to the application in the portion of the segment. For example, the amount of memory may be determined for a word processing application after the user preference as indicated by reaching a threshold level or input from a user interface. In this example, the execution files related to the world processing application are inspected to determine the amount of memory for execution, so this application may be cached for immediate response to the user. Also, using this example, the request is sent to the non-volatile memory to allocate the segment corresponding to the determined size and a response is received from the non-volatile memory regarding the amount of space available for the segment. Once the response from the non-volatile memory indicates there is enough space for the segment, the computing device reserves Inc portion of the segment for the execution files of the word processing application and then caches the execution files in the portion of the segment of the non-volatile memory. In another embodiment of operation 510, if the amount of spa available for the segment accommodates the data related to the application for the execution, additional files related to the application, such as the library or media, are also cached in the segment of the non-volatile memory.

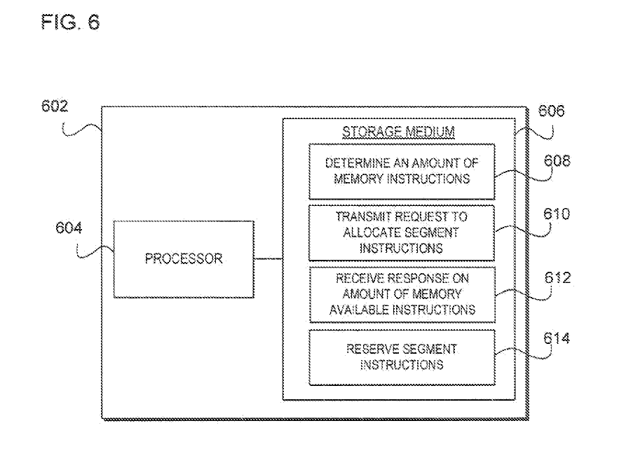

Referring now to FIG. 6, a block diagram of an example computing device 602 for determining an amount of memory for execution of an application based on an inspection of data related to the application and reserving a portion of a segment in the non-volatile memory for the execution of the application. Although computing device 602 includes processor 604 and machine-readable storage medium 606, it may also include other components that would be suitable to one skilled in the art. For example, the computing device 602 may include a non-volatile memory 112 as in FIG. 1. Additionally, the computing device 602 includes the functionality of the computing devices 100 and 300 as set forth above in FIG. 1 and FIG. 3.

The processor 604 may fetch, decode, and execute instructions 608, 610, 612, and 614. Processor 604 includes the functionality of the controllers 102 and 302 as set forth above in FIG. 1 and FIG. 3. Specifically, the processor 604 executes: determine an amount of memory, associated with the user preference, for execution of the application instructions 608; transmit a request to allocate a segment instructions 610, in which the segment corresponds to the amount of memory for execution of the application; receive a response on the amount memory available in the non-volatile memory instructions 612; and based on the response, reserve a portion of the segment instructions 614 for a file related to the execution of the application.

The machine-readable storage medium 606 may include instructions 608, 610, 612, and 614 for the processor 604 to fetch, decode, and execute. The machine-readable storage medium 606 may be an electronic, magnetic, optical, memory, flash-drive, or other physical device that contains or stores executable instructions. Thus, the machine-readable storage medium 606 may include for example, Random Access Memory (RAM), an Electrically Erasable Programmable Read-Only memory (EEPROM), a storage drive, a memory cache, network storage, a Compact Disc Read Only Memory (CD-ROM) and the like. As such, the machine-readable storage medium 606 can include an application and/or firmware which can be utilized independently and/or in conjunction with the processor 604 to fetch, decode, and/or execute instructions on the machine-readable store e medium 606. The application and/or firmware can be stored on the machine-readable storage medium 606 and/or stored on another location of tie computing device 602.

The embodiments described in detail herein determine an amount of memory, associated with a user preference, based on an inspection of data related to a application and reserves a portion of a segment in a non-volatile memory for execution of the application.

We claim:

1. A method comprising:
determining an amount of memory, associated with a user preference, for execution of an application based on an inspection of data related to the application;
transmitting a request to allocate a segment of a non-volatile memory, the segment corresponding to the amount of memory for execution of the application;
receiving a response of the amount of memory available for the segment from the non-volatile memory; and
based on the response, reserving a portion of the segment of the non-volatile memory for the execution of the application.

2. The method of claim 1 wherein the user preference includes at least one of a run-time analysis, a read write operation count, and a user interface.

3. The method of claim 1 wherein the data associated with the application includes at least one of a file and a logical block address.

4. The method of claim 3 wherein the file includes at least one of an application code, a library, a media, a launch file, and an executable file.

5. The method of claim 1 wherein the inspection of data associated with the application is an inspection done by either the computing device that contains the non-volatile memory or from a server that contains an amount of memory allocation data.

6. The method of claim 1 wherein the non-volatile is a solid state drive.

7. The method of claim 1 further comprising:
caching the data related to the application in the portion of the segment of the non-volatile memory.

8. A computing device comprising:
a memory controller to:
inspect data related to an application to determine an amount of memory for execution of the application associated with a user preference;
transmit a request to a non-volatile memory to allocate a segment corresponding to the amount of memory;
based on a response from the non-volatile memory, cache the data related to the application on a portion of the segment of the non-volatile memory for the execution of the application;
a non-volatile memory to:
receive a request to allocate the segment and allocate the amount of memory available for the segment to the memory controller.

9. The computing device of claim 8 wherein the user preference includes at least a run-time analysis, a read write operation count, and a user interface.

10. The computing device of claim 8 further comprising:
a second non-volatile memory to store the data related to the application.

11. The computing device of claim 9 wherein the non-volatile memory is a solid state drive and the second non-volatile memory is a disk drive.

12. The computing device of claim 8 wherein to inspect the data related to the application is done by either the computing device or from a server that contains an amount of memory allocation data.

13. A non-transitory machine-readable storage medium encoded with instructions executable by a processor, the storage medium comprising instructions to:
determine an amount of memory, associated with a user preference, for execution of an application based on an inspection of data related to an application;
transmit a request to allocate a segment of anon-volatile memory, wherein the segment corresponds to the amount of memory required for execution of the application;
receive a response of the amount of the required memory from the non-volatile memory; and
based on the response, reserve a portion of the segment of the non-volatile memory for a file related to the execution of the application.

14. The non-transitory machine readable storage medium comprising the instructions of claim 13 wherein the user preference includes at least a run-time analysis, read write operation count, and a user interface.

15. The non-transitory readable storage medium comprising the instructions of claim 13, wherein the inspection of the data related to the application is done by either a computing device that contains the non-volatile memory or from a server that contains an amount of memory allocation data.
